(19) United States
(12) Patent Application Publication
(10) Pub. No.: US 2026/0212737 A1
(43) Pub. Date: Jul. 23, 2026

(54) POS SYSTEM WITH ENHANCED ORDERING EXPERIENCE AND METHOD FOR OPERATING THE SAME

(71) Applicant: William Wu-Hua Sze, Covina, CA (US)

(72) Inventor: William Wu-Hua Sze, Covina, CA (US)

(21) Appl. No.: 19/030,999

(22) Filed: Jan. 17, 2025

(51) Int. Cl. G07G 1/14; G06Q 20/20

(52) U.S. Cl. CPC G07G 1/14; G06Q 20/202

(57) ABSTRACT

A POS system with enhanced ordering experience and a method for operating the POS system are disclosed. The POS system comprises: a server, providing business data and recording operation data; a master POS terminal, placed in a working space and connected to the server via a wide area network; and at least one slave POS terminal, connected to the master POS terminal via a local area network available in the working space. Each slave POS terminal operates to request business data needed from the server through the master POS terminal to show to customers, receive the operation data input by the customers, and upload the operation data to the server through the master POS terminal.

### FIELD OF THE INVENTION

The present invention relates to a point of sale (POS) system and a method for operating the POS system. More particularly, the present invention relates to a POS system and a method for operating the POS system to enhance ordering experience for catering industry.

### BACKGROUND OF THE INVENTION

POS system is an integrated hardware (such as cash register, barcode scanner) and software used for commercial transactions to help merchants sell, settle and manage related businesses. The main functions of the POS system include sales transaction processing, inventory management, employee management, process control and customer relationship management. Due to the introduction of automated process management, merchants who install POS systems can improve transaction efficiency, reduce manual operation errors, conduct real-time data management, enhance customer service experience, simplify business management, and even achieve the ideal of improving business intelligence.

The catering industry has introduced POS systems early and has achieved considerable success. In addition to the hardware improvements of these POS systems, software systems operating over the hardware are also constantly developed and updated. Existing POS systems are mostly used in ordering business, providing services including reservations, online self-service ordering, and diversified fee payments. Although related technologies have provided great operational convenience for restaurants or beverage shops, there are still some problems that need to be overcome in practice.

Common problems occur with system performance and maintenance. Multiple POS terminals of a POS system used for ordering food mostly interact with a server through direct network connection. This situation relies heavily on wide area network. Once the wide area network is unstable, the POS terminals will delay displaying with the updated status, causing customers to wait for a long time. As a result, operational efficiency deteriorates and even restaurant operations are interrupted. In addition, because multiple auxiliary applications are installed on the POS system, this results in too many workloads from the functions provided by the applications and a complex system structure. In terms of development and maintenance, it may increase the burden on manufacturers and reduce reliability and maintainability of the POS systems. What is even more troublesome is that since business modules influence each other in the POS system, a problem with one of the business modules may cause other business modules to fail to operate normally.

In order to solve the problems mentioned above and provide customers with better ordering experience, the present invention is developed.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to solve the problems, a (point of sale) POS system, comprises: a server, providing business data and recording operation data; and a master POS terminal, placed in a working space and connected to the server via a wide area network, operates to request business data from the server to show to customers, receive the operation data input by the customers, and upload the operation data to the server.

The POS system further comprises at least one slave POS terminal, connected to the master POS terminal via a local area network available in the working space, each slave POS terminal operates to request business data needed from the server through the master POS terminal to show to customers, receive the operation data input by the customers, and upload the operation data to the server through the master POS terminal.

According to the present invention, the master POS terminal may operate to request business data from the server to show to customers, receive the operation data inputted by the customers, and upload the operation data to the server.

According to the present invention, the master POS terminal may collect the operation data therefrom and from the at least one slave POS terminal, and periodically upload the collected operation data to the server.

According to the present invention, the master POS terminal and the slave POS terminal may use a browser to dynamically show the business data needed on a web application architecture of single page application.

According to the present invention, the server may further provide setting data. When the master POS terminal or the slave POS terminal is powered on to operate, the master POS terminal or the slave POS terminal is connected to the server to fetch the setting data for settings at startup and part of the business data for requests from the customers.

The POS system may further comprise a first mobile communication device connected to the server via the wide area network, wherein the server provides a management backend to the first mobile communication device and the management backend is used to modify the setting data and the business data and review the operation data.

According to the present invention, the server may further provide a plurality of application modules for the master POS terminal or the slave POS terminal to optionally download and install. Each application module performs specific operations and transmits data to each other through Application Programming Interface (API).

According to the present invention, a payment operation data includes a payment amount and a specified transaction method. A payment application module installed in the master POS terminal works to connect the master POS terminal to a payment system server providing payment service assigned in the specified transaction method to transfer the amount to a designated account.

According to the present invention, a takeout operation data includes purchase details, a payment amount and a takeout platform. A takeout application module installed in the master POS terminal works to connect the master POS terminal to a platform server of the takeout platform and provide purchase details, the payment amount and a ready time thereto.

A method for operating the POS system is also disclosed. The method comprises steps of: a) placing a master POS terminal and at least one slave POS terminal in a working space and powering on the master POS terminal and the at least one slave POS terminal to operate; b) connecting the master POS terminal a server via a wide area network and connecting the at least one slave POS terminal to the master POS terminal via a local area network available in the working space; c) fetching setting data for settings at startup and business data needed from the server by the master POS terminal and the at least one slave POS terminal; d) showing the business data to customers by the master POS terminal and the at least one slave POS terminal; e) receiving operation data input by the customers at the master POS terminal and the at least one slave POS terminal; f) periodically uploading the received operation data to the server by the master POS terminal; and g) repeating step d) to step f).

In step S04, the master POS terminal and the at least slave POS terminal may use a browser to dynamically show the business data needed on a web application architecture of single page application.

The method may further comprise steps between step c) and step g): c1) connecting a first mobile communication device to the server via the wide area network; and c2) providing a management backend to the first mobile communication device by the server wherein the management backend is used to modify the setting data and the business data and review the operation data.

A further step may be between step c) and step g): c3) download an application module from the server and install the application module for the master POS terminal or the slave POS terminal to perform specific operations. It is based on the fact that the server can provide a plurality of application modules. Each application module performs specific operations and transmits data to each other through API.

When a payment operation data includes a payment amount and a specified transaction method and a payment application module is installed in the master POS terminal, the method may further comprise a step between step c) and step g): c4) connecting the master POS terminal to a payment system server providing payment service assigned in the specified transaction method to transfer the amount to a designated account by the payment application module.

When a takeout operation data includes purchase details, a payment amount and a takeout platform and a takeout application module is installed in the master POS terminal, the method may further comprise a step between step c) and step g): c5) connecting the master POS terminal to a platform server of the takeout platform and providing purchase details, the payment amount and a ready time thereto by the takeout application module.

The present invention adopts a hybrid architecture of Client/Server and Browser/Server as a whole. The problems caused by wide area network unstable can be solved. Customers' ordering experience can be enhanced this way since display delays are effectively reduced. Meanwhile, each application function adopts modular development to build an application module. Application modules can be connected through API. When a problem happens in one application module, other application modules will not be affected. It can flexibly adjust and quickly expand functions according to future market business needs.

### BRIEF DESCRIPTION OF THE DRAWINGS

FIG. 1 is a schematic diagram of elements and application scenarios of an embodiment of a POS system with enhanced ordering experience according to the present invention.

FIG. 2 and FIG. 3 are flow charts of a method for operating the POS system to enhance ordering experience according to the present invention.

### DETAILED DESCRIPTION OF THE PREFERRED EMBODIMENTS

The present invention will now be described more specifically with reference to the following embodiments.

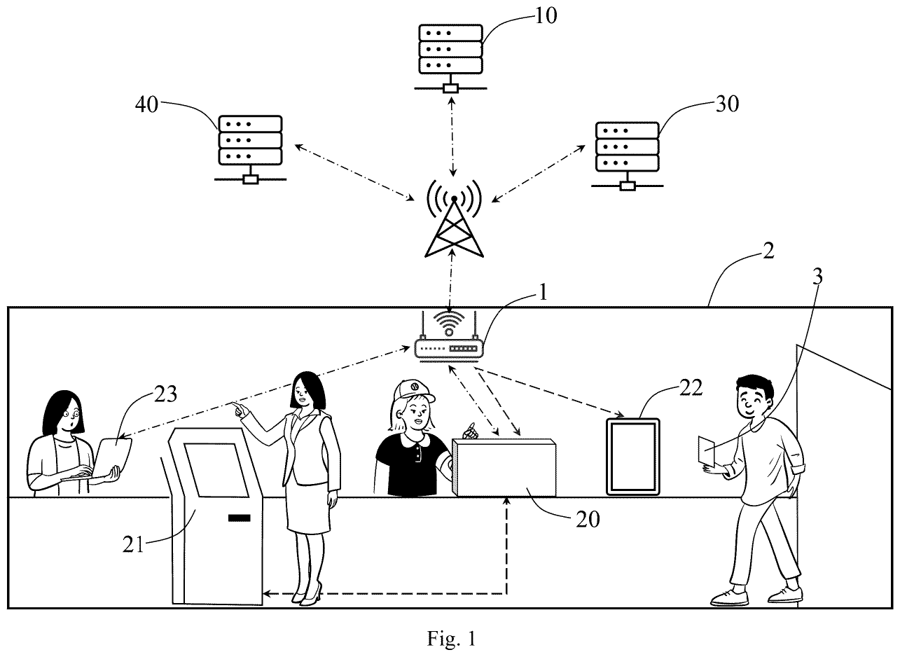

See FIG. 1. It is a schematic diagram of elements and application scenarios of an embodiment of a (point of sale) POS system with enhanced ordering experience according to the present invention.

The POS system includes a server 10, a master POS terminal 20, at least one slave POS terminal, and a first mobile communication device 30. In order to simplify the description, a first slave POS terminal 21 and a second slave POS terminal 22 are used in the embodiment for illustration. It should be noted that there may be any number of slave POS terminal in practice.

The hardware architecture of the server 10 of the POS system is like that of a general server, and may include a central processing unit, a memory, a storage device (such as a hard disk), an input/output unit, etc. Although these hardware are not shown in FIG. 1, they are architectures that those skilled in the server field should understand. In addition, one of the important hardware in the server 10 is a network communication interface (sometimes including program software running on the operating system), which connects the server 10 to the external network through a router 1. The network communication interface may include hardware such as network cards, connection cables, and wireless communication modules. Application modules of the POS system which will be mentioned later are technical elements for running the POS system by utilizing or cooperating with the above-mentioned architecture of the server 1. Therefore, the application modules may be software that contains specific program code and data, and runs in at least part of the hardware architecture under the operating system. For example, the program code and related data files are stored in a storage device, temporarily stored in the memory under the operation of the operating system, and dynamically called and executed by the central processor. On the other hand, these application modules may also be specially designed hardware, such as application-specific integrated circuits (ASICs) or external cards, to perform the specified functions. Furthermore, these technical elements may be partly software and partly hardware, and can be effectively integrated according to the needs of product designers. The server 10 may be a standalone machine. It can be one or a cluster in a public cloud or a private cloud.

The main functions of the server 1 are providing business data and recording operation data. Here, business data refer to any data related to running a business. For the catering industry, the business data may be names, images, prices or quantity of food or beverages that are provisioned by a restaurant (data on the menu). The business data may also be a discount project or ads for some dishes on a specific holiday. The business data may further be articles introducing ingredients or information to promote a restaurant. It is obvious that the substance of the business data would vary from time to time as changes in costs or marketing strategies. Therefore, catering operators using the POS system can modify the business data according to their needs. The operation data refers to any feedback from customers, including but not limited to quantity, specification and total amount of food or beverage purchased, payment methods, discounts, purchase time and location. The server 1 keeps all the operation data for the catering operator to review.

The server 1 also provides setting data. The setting data refers to the information or setting required by the remote master POS terminal or slave POS terminal when it is booted. Specifically, the setting data may be an encryption private key to initiate the master POS terminal to run when it is authorized to use. The setting data may also to be some key parameters which enable some functions of the slave POS terminal available. The setting data may be just a pair of account and password that the catering operator uses to control all the POS terminals in his restaurant in case his clerks misuse these machines.

According to the present invention, the type of the master POS terminal or slave POS terminal is not limited. In FIG. 1, the master POS terminal 20 is a desktop POS machine, operated by a clerk according to customer needs. The first slave POS terminal 21 is a self-service POS machine (kiosk) which is operated by the customer. The second slave POS terminal 22 is a mobile POS machine and can collaborate with customers' smartphones or tablets. The master POS terminal and the slave POS terminal both have set operating functions and can operate independently. Differences between the master POS terminal and the slave POS terminal are that the master POS terminal can directly connect to the server 1 but the slave POS terminal cannot, and the external communication channel of the slave POS terminal is limited to local area network while that of the master POS terminal is not.

According to the present invention, the master POS terminal 20 should be placed in a working space 2 and connected to the server 1 via a wide area network. The working space 2 may be an independent restaurant or beverage shop where service is provided to customers and POS terminals are required. More precisely, the working space 2 is where a local area network is available through a router 1 or Ethernet wires so that the first slave POS terminal 21 and the second slave POS terminal 22 are able to be connected to the master POS terminal 20. The first slave POS terminal 21 is wiredly connected to the master POS terminal 20 while the second slave POS terminal 22 is wirelessly connected to the master POS terminal 20 in the embodiment. Connections through the local area network is marked by thick dashed-line arrow.

The master POS terminal 20 can operate to request business data from the server 1 to show to customers. A browser or app installed in the master POS terminal 20 may form a display interface on its screen to sequentially disclose the business data from the server 1. For example, the display interface may shape a frame of a menu, and the business data are the content of the menu. The master POS terminal 20 can also receive the operation data inputted by the customers, and upload the operation data to the server 1. It should be noted that the master POS terminal 20 and the server 1 are connected through a wide area network (marked by dashed dotted line arrow), rather than the local area network, since the server 1 is usually far away from the working space 2. The local area network cannot provide long-distance communication services. In this embodiment, the clerk enters the customers' needs. However, generally, customers can input their needs themselves with the master POS terminal 20.

The slave POS terminals are doing similar jobs but limited in some details. Take the first slave POS terminal 21 for example. The first slave POS terminal 21 also request business data needed from the server 1 to show to customers. However, the business data has to be transmitted through the master POS terminal 20. The server 1 will not communicate with the first slave POS terminal 21 directly. Therefore, the first slave POS terminal 21 uploads the operation data to the server 1 through the master POS terminal 20. The job function that the first slave POS terminal 21 and the master POS terminal 20 have in common is to receive the operation data input by the customers.

Since operation data may be generated at any time, if it is to be transmitted to the server 1 in real time, it will occupy too many network resources. Therefore, the upload of operation data should be batch and periodic. In addition, the upload of operation data is preferably performed by one machine. The master POS terminal 20 is designed to fulfill the requirement. The master POS terminal 20 collects the operation data from itself and from the slave POS terminals, and periodically uploads the collected operation data to the server 1. For example, upload the collected operation data every 10 minutes or use the off-peak time of data transmission to upload collected operation data.

As mentioned above, a browser or app is used to form the display interface and show the business data. For the master POS terminal 20 and the slave POS terminals, it is best to use the browser to dynamically show the business data needed in a web application architecture of single page application (SPA). In a SPA, all content of the entire application is presented on one web page. It can have a better presentation effect and avoid network delays, causing consumers to wait.

As mentioned above, the server 1 provides setting data to the master POS terminal 20 and the slave POS terminals. When the master POS terminal 20 or any of the slave POS terminal is powered on to operate, the master POS terminal 20 or the slave POS terminal is connected to the server 1 (the slave POS terminal is connected to the server 1 though the master POS terminal 20 via the wide area network) to fetch the setting data for settings at startup. Meanwhile, part of the business data in the server 1 are also fetched along with the setting data. The part of the business data is for requests from the customers. When a brand new POS terminal is applied, the part of the business data are necessary since there are no business data prestored in the machine after it is deployed. However, when an online POS terminal restarts, only some updated business data, such as changed price of a meal, are requested.

For catering operators, it is very important to be able to keep track of business conditions, such as sales performance, costs, etc. Therefore, the POS system can further include a first mobile communication device 23. The first mobile communication device 23 is a portable communication machine, such tablet, smartphone or even a laptop shown in FIG. 1. The first mobile communication device 23 is connected to the server 1 via the wide area network. According to the present invention, the server 1 can provide a management backend to the first mobile communication device 23. The management backend is an interface for systematically showing the business data for review. Meanwhile, the management backend can be used to modify the setting data and the business data in the server 1 when needed. The advantage of using the mobile communication device is that any non-PC mobile communication device can become a backend device after installing the necessary applications. It can save the overall cost of the system.

The above-mentioned POS system, in addition to the hardware architecture of the POS terminals and the server 1, also includes application modules that run on these devices. Each of the application module performs specific operations, e.g. displaying a menu, counting the quantity and amount of food ordered, etc. Some basic application modules are installed in each POS terminal before deploying. Some application modules which are rarely used may be dynamically installed. The server 1 has and provides a lot of application modules for the master POS terminal 20 or the slave POS terminals to optionally download and install. In order to make the newly downloaded application module work smoothly with the ones already in the POS terminals, each application module can transmit data to each other through Application Programming Interface (API). This is an application of microservice architecture. When a problem occurs in one application s module, other application modules will not be affected.

Amount all the operation data, 2 of them are important: a payment operation data and a takeout operation data. The payment operation data includes a payment amount and a specified transaction method. A payment application module is designed to deal with the payment operation data. The payment application module is installed in the master POS terminal 20. It works to connect the master POS terminal 20 to a payment system server 30. The payment system server 30 provides payment service which is assigned in the specified transaction method to transfer the amount to a designated account. The transaction method may be credit card payment or third-party payment. The payment service indicates details of cash flow (account to account). The payment system server 30 payment system server 30 is the entity that processes transactions. The takeout operation data includes purchase details, a payment amount and a takeout platform. A takeout application module is designed to deal with the takeout operation data. The takeout application module is also installed in the master POS terminal 20, working to connect the master POS terminal 20 to a platform server 40 of the takeout platform. The takeout application module enables the master POS terminal 20 to provide purchase details, the payment amount and a ready time to the platform server 40. The platform server 40 can hence send a rider to pick up the meal. Here, the takeout platform refers to any company or group providing food delivery service, such as UberEATS, DoorDash, etc. The platform server 40 is the execution entity to match supply and demand sides of the delivery service and notify the restaurant to arrange ordered food.

Based on the POS system, a method for operating the POS system is also disclosed in the present invention. The method is implemented by the application modules for the POS terminal as well as the applications run in the server 1.

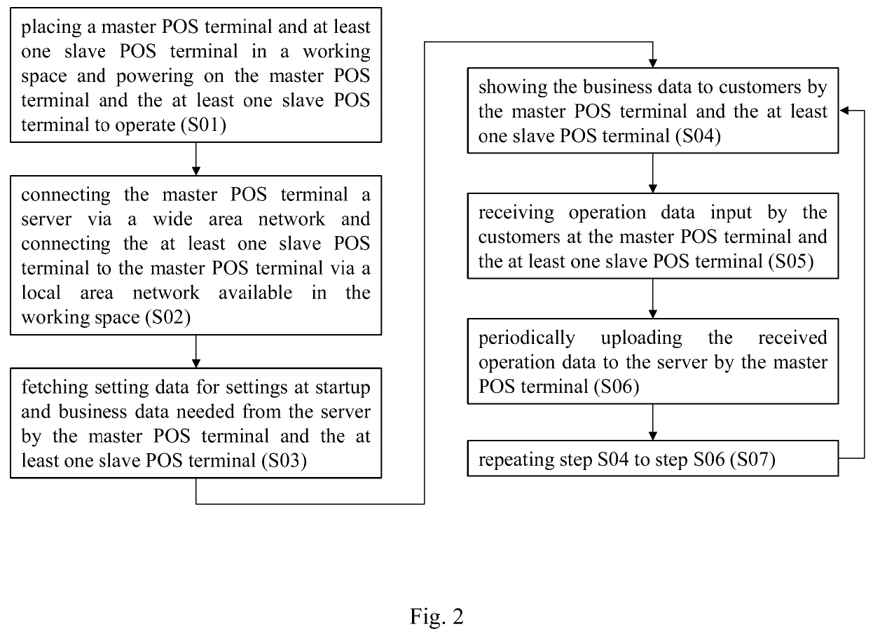

See FIG. 2. It is a flow chart of a method for operating the POS system mentioned above to enhance ordering experience according to the present invention. A first step of the method is placing a master POS terminal and at least one slave POS terminal in a working space and powering on the master POS terminal and the at least one slave POS terminal to operate (S01). A second step of the method is connecting the master POS terminal a server via a wide area network and connecting the at least one slave POS terminal to the master POS terminal via a local area network available in the working space (S02). The master POS terminal and the slave POS terminal should be in the local area network environment to connect. Before they are ready to work, connectivity should be ready for data transmission. A third step of the method is fetching setting data for settings at startup and business data needed from the server by the master POS terminal and the at least one slave POS terminal (S03). Setting data and business data are obtained for the POS terminals before they can properly run.

A fourth step of the method is showing the business data to customers by the master POS terminal and the at least one slave POS terminal (S04). This step makes the POS terminals able to interact with the customers. A fifth step of the method is receiving operation data input by the customers at the master POS terminal and the at least one slave POS terminal (S05). The POS terminals continuously get what customers ordered by this step. A sixth step of the method is periodically uploading the received operation data to the server by the master POS terminal (S06). From step S04 to S06, a batch of received operation data collected by the master POS terminal have been sent to the server to preserve for review. A last step of the method is repeating step S04 to step S06. This step is to generate another batch of received operation data to be collected and sent.

It should be noticed that in step S04, the master POS terminal and the at least slave POS terminal all use a browser to dynamically show the business data needed on a web application architecture of single page application.

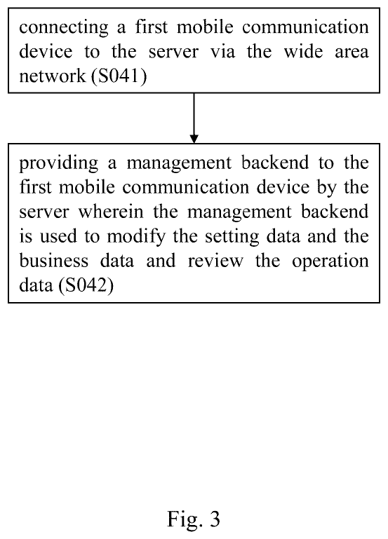

See FIG. 3. It is another flow chart showing additional steps of the method. The method according to the present invention may also comprise the below steps between step S04 and step S07. A step S041 is connecting a first mobile communication device to the server via the wide area network. This step is to include the first mobile communication device in the POS system. A step S042) is providing a management backend to the first mobile communication device by the server wherein the management backend is used to modify the setting data and the business data and review the operation data. Thus, the first mobile communication device is able to show the operation data to the catering operator.

When some application module is required, a step S043 can be included between step S04 and step S07: download an application module from the server and install the application module for the master POS terminal or the slave POS terminal to perform specific operations. The premise of this step is that the server provides a number of application modules, and each application module performs specific operations and transmits data to each other through API.

As mentioned above, the payment operation data which includes a payment amount and a specified transaction method is applied in the POS system. When the payment application module is installed in the master POS terminal, a step S044 can be included between step S04 and step S07: connecting the master POS terminal to a payment system server providing payment service assigned in the specified transaction method to transfer the amount to a designated account by the payment application module.

Similarly, the takeout operation data which includes purchase details, a payment amount and a takeout platform is also applied in the POS system. When the takeout application module is installed in the master POS terminal, a step S045 can be included between step S04 and step S07: connecting the master POS terminal to a platform server of the takeout platform and providing purchase details, the payment amount and a ready time thereto by the takeout application module.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A (point of sale) POS system, comprising:
a server, providing business data and recording operation data; and
a master POS terminal, placed in a working space and connected to the server via a wide area network, operates to
request business data from the server to show to customers,
receive the operation data input by the customers, and
upload the operation data to the server.

2. The POS system according to claim 1, further comprises at least one slave POS terminal, connected to the master POS terminal via a local area network available in the working space, each slave POS terminal operates to
request business data needed from the server through the master POS terminal to show to customers,
receive the operation data input by the customers, and
upload the operation data to the server through the master POS terminal.

3. The POS system according to claim 2, wherein the master POS terminal collects the operation data therefrom and from the at least one slave POS terminal, and periodically uploads the collected operation data to the server.

4. The POS system according to claim 2, wherein the master POS terminal and the slave POS terminal uses a browser to dynamically show the business data needed on a web application architecture of single page application.

5. The POS system according to claim 1, wherein the server further provides setting data, and when the master POS terminal or the slave POS terminal is powered on to operate, the master POS terminal or the slave POS terminal is connected to the server to fetch the setting data for settings at startup and part of the business data for requests from the customers.

6. The POS system according to claim 5, further comprises a first mobile communication device connected to the server via the wide area network, wherein the server provides a management backend to the first mobile communication device and the management backend is used to modify the setting data and the business data and review the operation data.

7. The POS system according to claim 1, wherein the server further provides a plurality of application modules for the master POS terminal or the slave POS terminal to optionally download and install, and each application module performs specific operations and transmits data to each other through Application Programming Interface (API).

8. The POS system according to claim 1, wherein a payment operation data includes a payment amount and a specified transaction method, and a payment application module installed in the master POS terminal works to connect the master POS terminal to a payment system server providing payment service assigned in the specified transaction method to transfer the amount to a designated account.

9. The POS system according to claim 1, wherein a takeout operation data includes purchase details, a payment amount and a takeout platform, and a takeout application module installed in the master POS terminal works to connect the master POS terminal to a platform server of the takeout platform and provide purchase details, the payment amount and a ready time thereto.

10. A method for operating a POS system, comprising steps of:
a) placing a master POS terminal and at least one slave POS terminal in a working space and powering on the master POS terminal and the at least one slave POS terminal to operate;
b) connecting the master POS terminal a server via a wide area network and connecting the at least one slave POS terminal to the master POS terminal via a local area network available in the working space;
c) fetching setting data for settings at startup and business data needed from the server by the master POS terminal and the at least one slave POS terminal;
d) showing the business data to customers by the master POS terminal and the at least one slave POS terminal;
e) receiving operation data input by the customers at the master POS terminal and the at least one slave POS terminal;
f) periodically uploading the received operation data to the server by the master POS terminal; and
g) repeating step d) to step f).

11. The method according to claim 10, wherein the master POS terminal and the at least slave POS terminal use a browser to dynamically show the business data needed on a web application architecture of single page application.

12. The method according to claim 10, further comprises steps between step c) and step g):
c1) connecting a first mobile communication device to the server via the wide area network; and
c2) providing a management backend to the first mobile communication device by the server wherein the management backend is used to modify the setting data and the business data and review the operation data.

13. The method according to claim 10, further comprising a step between step c) and step g):
c3) download an application module from the server and install the application module for the master POS terminal or the slave POS terminal to perform specific operations.

14. The method according to claim 13, wherein the server further provides a plurality of application modules, and each application module performs specific operations and transmits data to each other through API.

15. The method according to claim 10, wherein a payment operation data includes a payment amount and a specified transaction method, and a payment application module is installed in the master POS terminal.

16. The method according to claim 15, further comprises a step between step c) and step g):
c4) connecting the master POS terminal to a payment system server providing payment service assigned in the specified transaction method to transfer the amount to a designated account by the payment application module.

17. The method according to claim 10, wherein a takeout operation data includes purchase details, a payment amount and a takeout platform, and a takeout application module is installed in the master POS terminal.

18. The method according to claim 17, further comprises a step between step c) and step g):
c5) connecting the master POS terminal to a platform server of the takeout platform and providing purchase details, the payment amount and a ready time thereto by the takeout application module.
